(19) United States
(12) Patent Application Publication
(10) Pub. No.: US 2006/0191833 A1
(43) Pub. Date: Aug. 31, 2006

(54) Pressurized erosion chlorinator

(75) Inventors: George C. Greene III, Charleston, SC (US); George C. Greene IV, Charleston, SC (US); Gregory De Haan, Zeeland, MI (US); Jack G. Koedoot, Hudsonville, MI (US); Ross T. Van Klompenberg, Hudsonville, MI (US)

Correspondence Address: HAMMER & HANF, PC, 3125 SPRINGBANK LANE, SUITE G, CHARLOTTE, NC, 28226, US

(73) Assignee: Water Missions International

(21) Appl. No.: 11/340,367

(22) Filed: Jan. 26, 2006

Related U.S. Application Data
(60) Provisional application No. 60/647,152, filed on Jan. 26, 2005.

(51) Int. Cl. C02F 1/76

(52) U.S. Cl. 210/206

(57) ABSTRACT

The present invention is an erosion chlorinator, having a contact chamber with a water inlet flow orifice at the first end and a water discharge orifice in the side wall. Both orifices are in communication with the contact chamber. Seated within the contact chamber is an inverted cone having a narrow end and a wide end. The orifice at the narrow end is in communication with the water inlet orifice. An elongated chlorine tablet chamber is provided, the first end of which is in communication with the second end of the contact chamber and extends into the contact chamber, but is spaced from the wide end of the inverted cone. The second end of the elongated chlorine chamber has a flange around the circumference, an O-ring and an end plate where the O-ring is engaged between the flange and the end plate. This chlorinator may be used in pressurized system.

### RELATED CASES

This application claims the Priority of the Provisional Application Ser. No. 60/647,152 filed Jan. 26, 2005.

### BACKGROUND OF THE INVENTION

The present invention provides an erosion chlorinator. While erosion chlorinators are known most are not designed to work with a pressurized system. An example of a pressurized system to treat water is discussed in U.S. Pat. No. 6,936,176 incorporated here by reference.

### SUMMARY OF THE INVENTION

The present invention is drawn to an erosion chlorinator, which comprises a contact chamber having a first end, a second end and a side wall; where the contact chamber has a water inlet flow orifice at the first end in communication with the contact chamber. The contact chamber has a water discharge orifice in the side wall which is in communication with the contact chamber. Seated within the contact chamber, is an inverted cone having a narrow end and a wide end which is large enough to accept a chlorine tablet, with an orifice at the narrow end which is in communication with the water inlet orifice. This inverted cone is intersected with a diffusion plate, where the diffusion plate has a plurality of orifices. Above the diffusion plate is a series of parallel plates perpendicular to the diffusion plate and attached to the inverted cone. An elongated chlorine tablet chamber is provided which has a first end and a second end, the first end of the elongated chlorine tablet chamber is in communication with the second end of the contact chamber and extends into the contact chamber, but is spaced from the wide end of the inverted cone. The second end of the elongated chlorine chamber has a flange around the circumference of the elongated chlorine chamber, where the flange has a plurality of notches along the outside circumference of the flange. An O-ring and an end plate are provided; the end plate has a plurality of orifices spaced for communication with the plurality of notches in the flange. Fastening means are provided. These fastening means are adapted for engagement with the notches in the flange and the orifices in the end plate. The O-ring is engaged between the flange and the end plate, and held together by the fastening means. This chlorinator may be used with a pressurized system.

### BRIEF DESCRIPTION OF THE DRAWINGS

The foregoing will become more readily apparent by referring to the following detailed description and the appended drawings in which:

FIG. 1 is a cut away side view of the chlorination unit.

FIG. 2 is a perspective view of the chlorination unit.

FIG. 3 is another cut away side view of the chlorination unit.

FIG. 4 is another cut away side view of the chlorination unit.

FIG. 5 is a top view of the chlorination unit.

FIG. 6 is a perspective view of the chlorine tablet chamber.

FIG. 7 is another perspective view of the chlorine tablet chamber.

FIG. 8 is a perspective view of the end plate.

FIG. 9 is a top, bottom and side view of the end plate.

FIG. 10 is a perspective view of the flange.

FIG. 11 is a top, bottom and side view of the flange.

FIG. 12 is a cut away side view of another embodiment of the chlorination unit.

FIG. 13 is a perspective view of another embodiment of the chlorination unit.

FIG. 14 is another cut away side view of another embodiment of the chlorination unit.

FIG. 15 is another cut away side view of another embodiment of the chlorination unit.

FIG. 16 is a top view of another embodiment of the top for chlorination unit.

FIG. 17 is a side view of another embodiment of the top for chlorination unit.

FIG. 18 is a bottom view of another embodiment of the top for chlorination unit.

FIG. 19 is a front view of the security prong.

FIG. 20 is a side view of the security prong.

FIG. 21 is a top view of the security prong.

FIG. 22 is a perspective view of another embodiment of the top of the chlorination unit.

FIG. 23 is a perspective view of the top of the chlorination unit with the top removed.

FIG. 24 is a perspective view of the top of the chlorination unit with the top secured.

FIG. 25 is a perspective view of the top of the chlorination unit with the top being removed.

FIG. 26 is a perspective view of the top of the chlorination unit with the security prong being removed.

FIG. 27 is a perspective view of the top of the chlorination unit with the top being removed.

FIG. 28 is a perspective view of the top of the chlorination unit with the top removed.

FIG. 29 is a perspective view of the top of the chlorination unit with the security prong engaged in the top for removal.

### DETAILED DESCRIPTION OF THE INVENTION

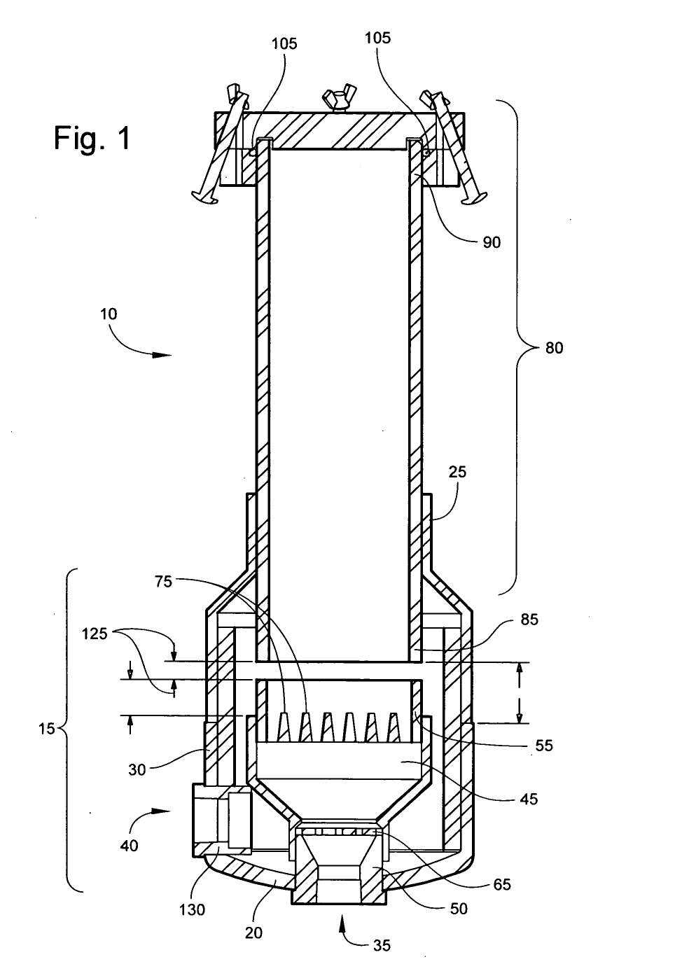

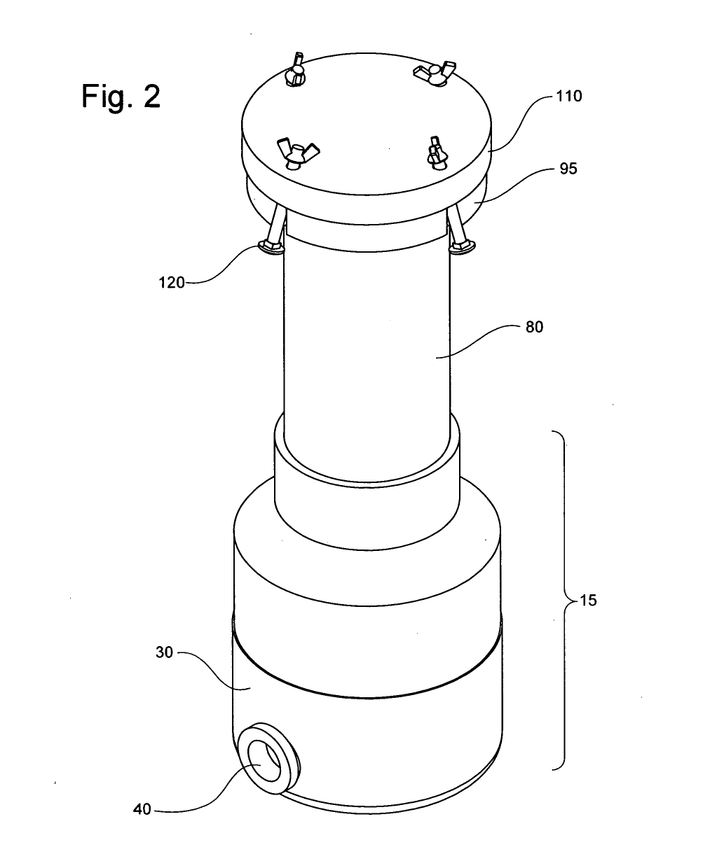

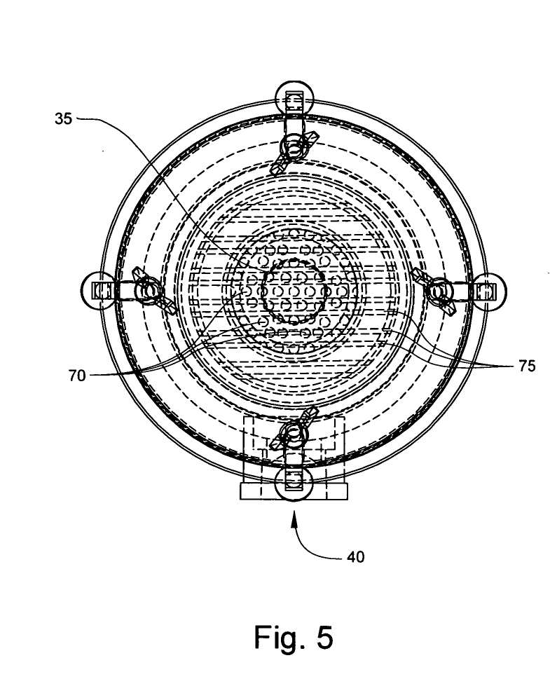

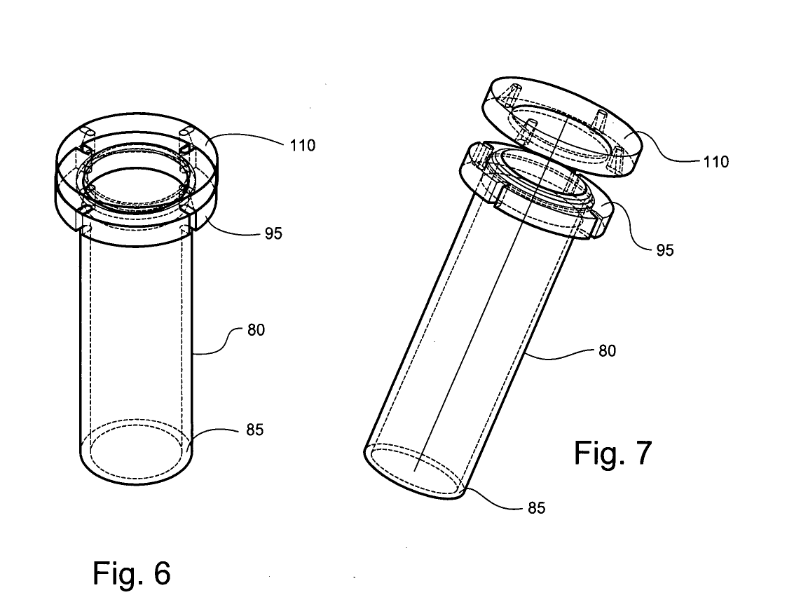

The present invention is drawn to an erosion chlorinator 10, FIG. 1. This erosion chlorinator comprises a contact chamber 15 having a first end 20, a second end 25 and a side wall 30; where the contact chamber has a water inlet flow orifice 35 at the first end 20 in communication with the contact chamber. The contact chamber has a water discharge orifice 40, FIG. 2, in the side wall 30 which is in communication with the contact chamber 15. Seated within the contact chamber 15, is an inverted cone 45 having a narrow end 50 and a wide end 55. The wide end 55 is large enough to accept a chlorine tablet. An orifice 35 is provided at the narrow end 50 of the inverted cone 45 which is in communication with the water inlet orifice 35. This inverted cone 45 is intersected with a diffusion plate 65. The diffusion plate is provided with a plurality of orifices 70, FIG. 5. Above the diffusion plate 65 is a series of parallel plates 75 perpendicular to the diffusion plate 65 and attached to the inverted cone 45. An elongated chlorine tablet chamber 80 is provided which has a first end 85 and a second end 90. The first end 85 of the elongated chlorine tablet chamber 80 is in communication with the second end 25 of the contact chamber 15 and extends into the contact chamber 15, but is spaced from the wide end 55 of the inverted cone 45. The second end 25 of the contact chamber 15 is fixed to the first end 85 of the elongated chlorine tablet chamber 80.

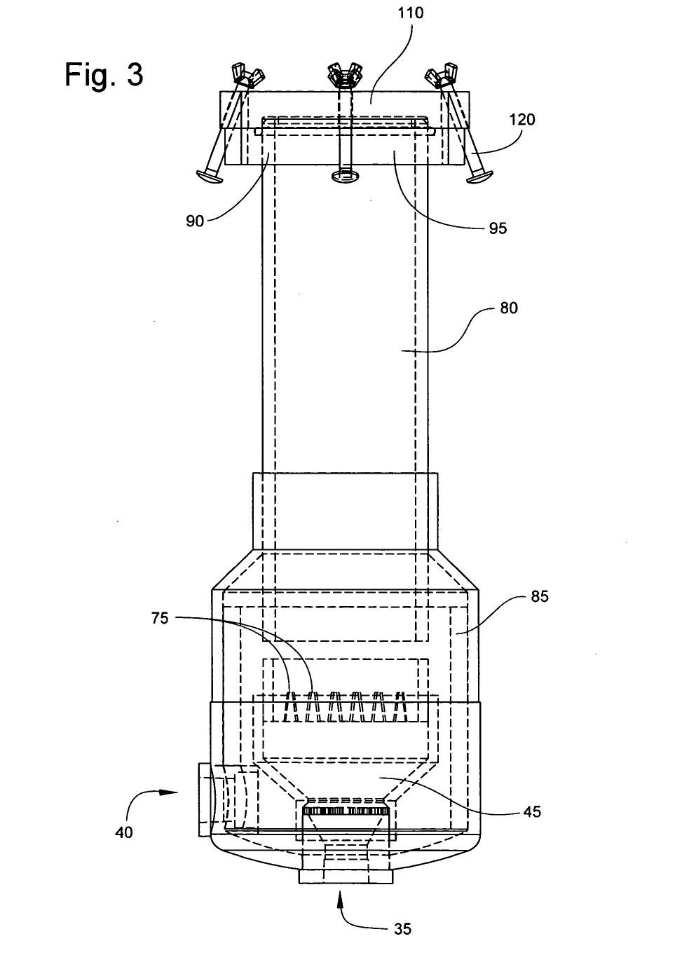

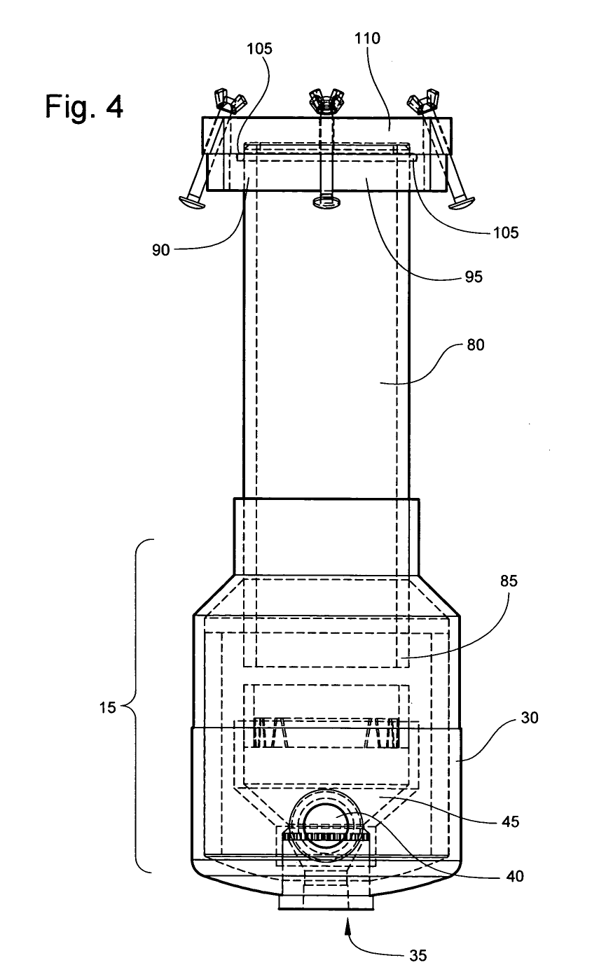

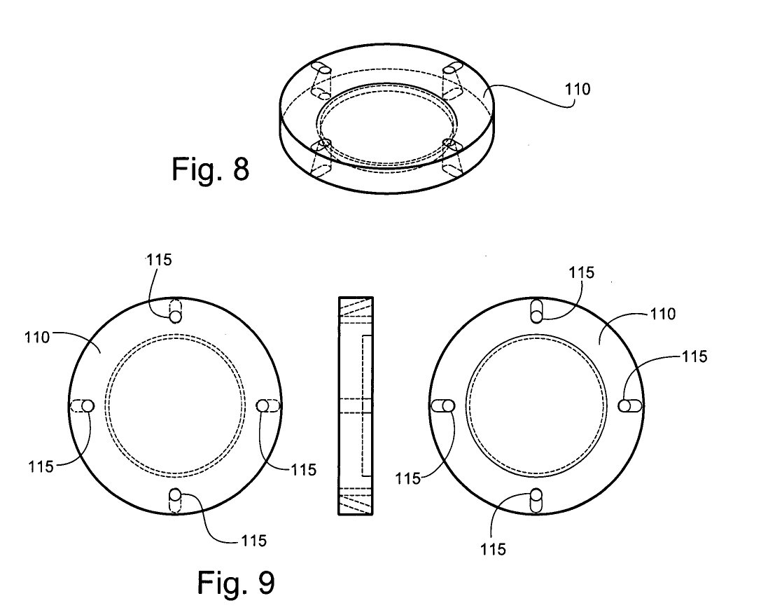

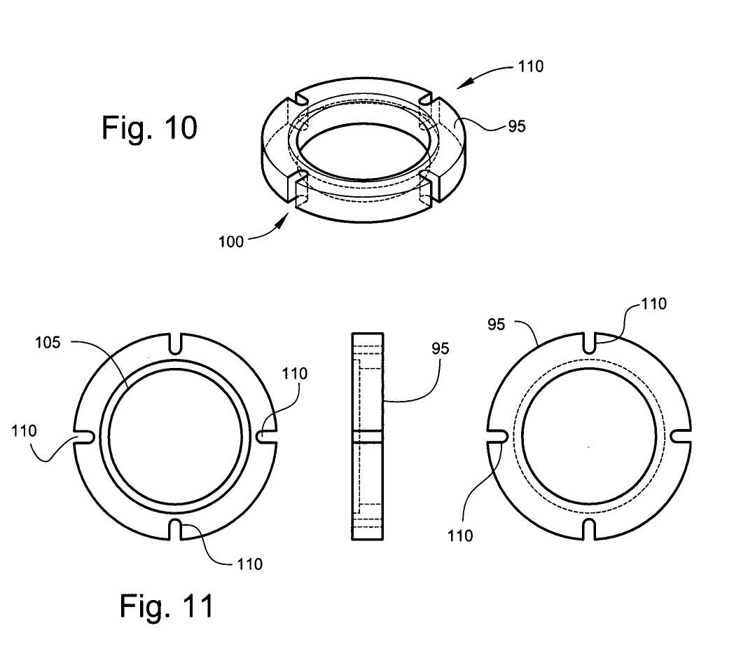

The second end of the elongated chlorine chamber 80 has a flange 95, FIG. 11, around the circumference of the elongated chlorine chamber 80, where the flange 95 has a plurality of notches 100, FIG. 11, along the outside circumference of the flange 95. An O-ring 105, FIG. 4, and an end plate 110, FIG. 9, are also provided. The end plate 110, FIG. 8, has a plurality of orifices 115, FIG. 9, spaced for communication with the plurality of notches 100, FIG. 10, in the flange 95. Fastening means 120, FIG. 3, are provided. These fastening means 120 are adapted for engagement with the notches 100, FIG. 11, in the flange 95 and the orifices 115, FIG. 9, in the end plate 110. The O-ring 105, FIG. 11, is engaged between the flange 95 and the end plate 110, and held together by the fastening means 120.

In one embodiment of the invention, the elongated chlorine chamber 80 is made from a transparent material. This transparent material for the elongated chlorine chamber 80 can be a transparent polyvinyl chloride PVC. Use of a transparent material enables an operator to see the number of chlorine tablets that are left in the system without having to shut down the chlorinator. This enables longer running times and allows the operator to monitor the remaining amount of chlorine effectively. The elongated chlorine chamber can be sized to hold plurality three inch diameter chlorine tablets. In one embodiment the number is about ten but this can be increased or decreased by extending or reducing the length of the elongated chorine tablet chamber 80.

This erosion chlorinator can operate at pressures up to 250 psig (pounds per square inch gauge). The tops of these units are engineered to withstand pressures as high as 400 psig. Often these units are run at pressures ranging from 10 to 250 psig. In one of the embodiments of this invention these chlorinators run between 30 to 180 psig. In some application this unit may be run at lower pressures of between 1 to 80 psig. The erosion chlorinator can operate at a flowrate ranging from 0.5 gpm (gallons per minute) to 15 gpm. The erosion chlorinator introduces a known and constant concentration of chlorine into a stream of water flowing, either under pressure or at atmospheric pressure, through the chlorinator. By controlling the flowrate of water through the chlorinator, and then combining the effluent from the chlorinator with the bypass stream, the concentration of chlorine in the mixed stream can be controlled at any desired constant concentration. It has been found in practice that a concentration of from less than 1 ppm (parts per million) to greater than 8 ppm works well when added to a stream of water flowing from less about 1 gpm to about 10 gpm.

The erosion chlorinator described above has the second end of the elongated chlorine chamber is designed to be easily removed to allow introduction of the chlorine tablets, and then to be easily resealed, an “O” ring is used to provide a seal between the top and the elongated chlorine chamber, that does not leak at pressures up to 400 psig. Four bolts with wing nuts can be used as the fastening means 120, FIG. 2, to secure the top.

The inlet flow chamber, which is the inverted cone 45, is designed to baffle the incoming water stream and distribute a uniform flow of water over the surface area of the bottom chlorine tablet, thus ensuring a constant and controllable rate of dissolution of chlorine from the tablet into the water. The contact chamber is designed to support the bottom chlorine tablet as well as the column of chlorine tablets, and, at the same time, maximize the surface area of the bottom chlorine tablet presented to the stream of water. Chlorine tablets rest on top of the parallel plates 75, FIG. 1. The wall of the contact chamber 55 contains the bottom chlorine tablet and serves as an overflow weir for the water as it exits the chamber. Chlorinated water overflowing the weir, flows through the annulus 125, FIG. 1, between the wider end 55 of the inverted cone 45 and the outer wall 85 of the chlorinator, and exits through a fitting 130 located on the side of the chlorinator at the bottom of the exit annulus.

In another embodiment of the invention a chlorinator that uses a chlorine tablet 10 comprises: a tablet chamber 80; a contact chamber 15, the contact chamber having an inner chamber 45 with a water inlet 35 and an outer chamber 30 with a water outlet 40; and a water diffuser 65 located next to the inlet, and a tablet holder 55 & 75 located adjacent the tablet chamber. In operation a tablet is placed in the tablet chamber and rests on the tablet holder, water enters the water inlet 35 and comes in contact with the tablet in the inner chamber and passes to the outlet chamber and is discharged via the water outlet 40. This chlorinator can operate under pressure. This chlorinator further comprises a sealable top attached to the tablet chamber opposite the contact chamber 80. The tablet holder comprises a series of parallel plates 75 within the inner chamber perpendicular to the diffuser. This chlorinator can introduce a concentration of chlorine from 0.5 ppm to 10 ppm of chlorine into a stream of water flowing at a rate between 0.5 gpm to 15 gpm.

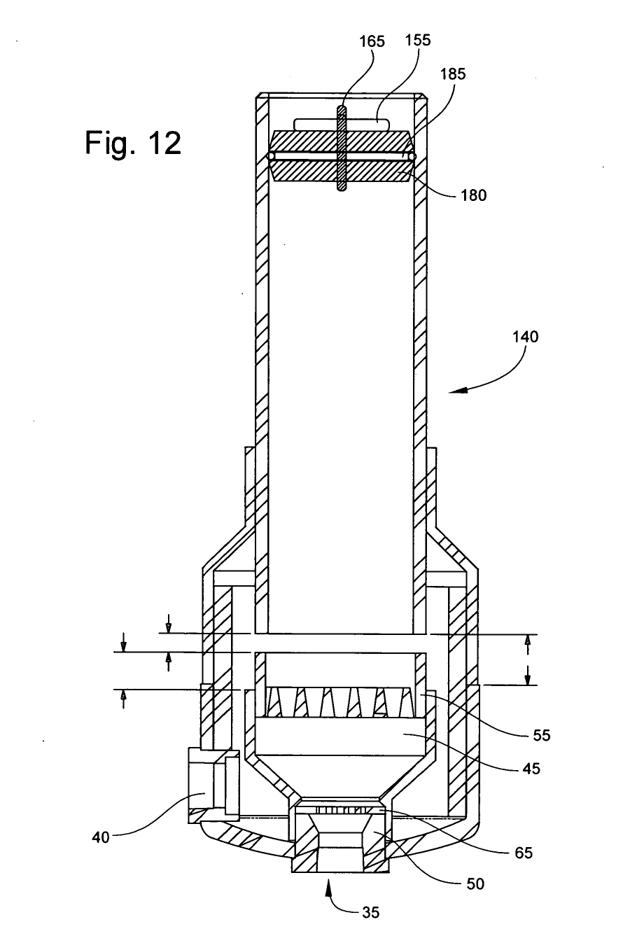

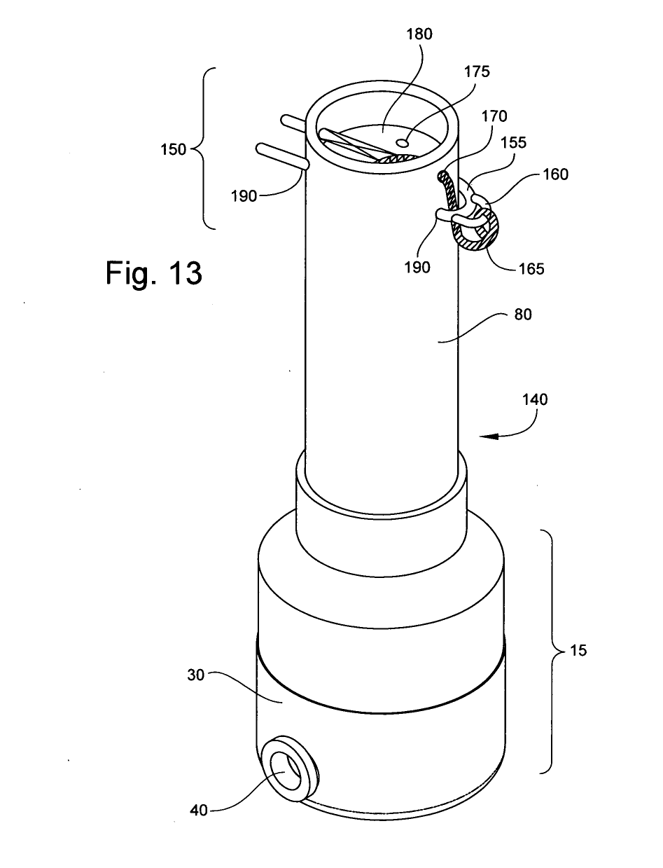

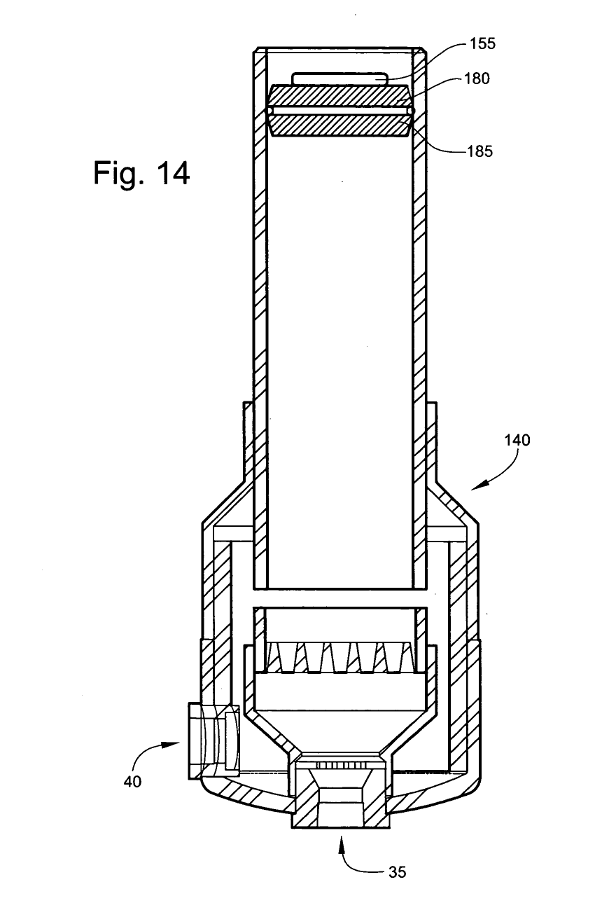

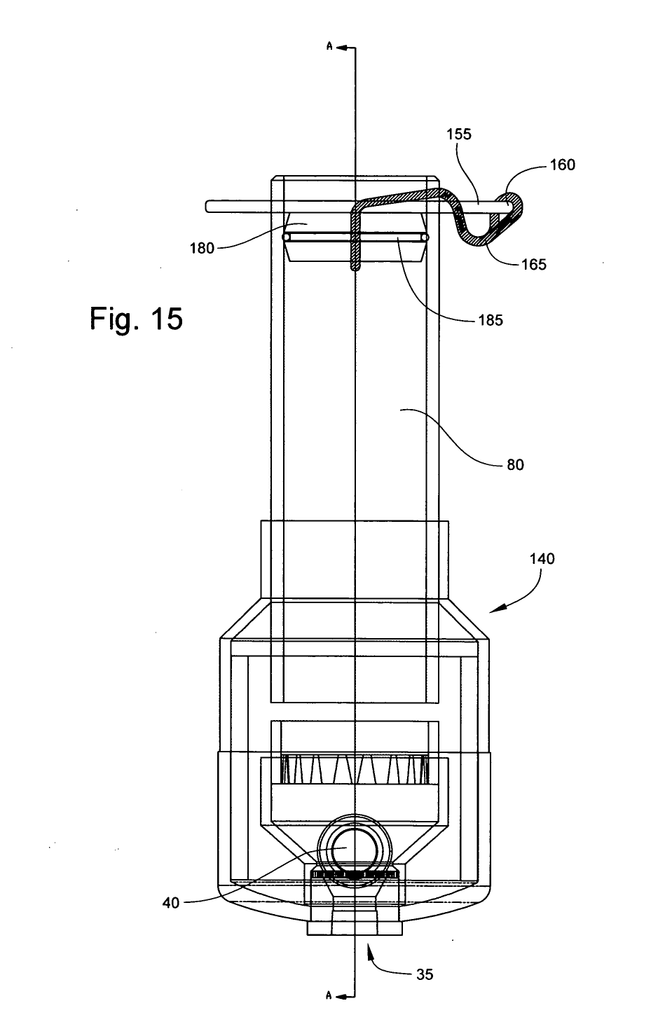

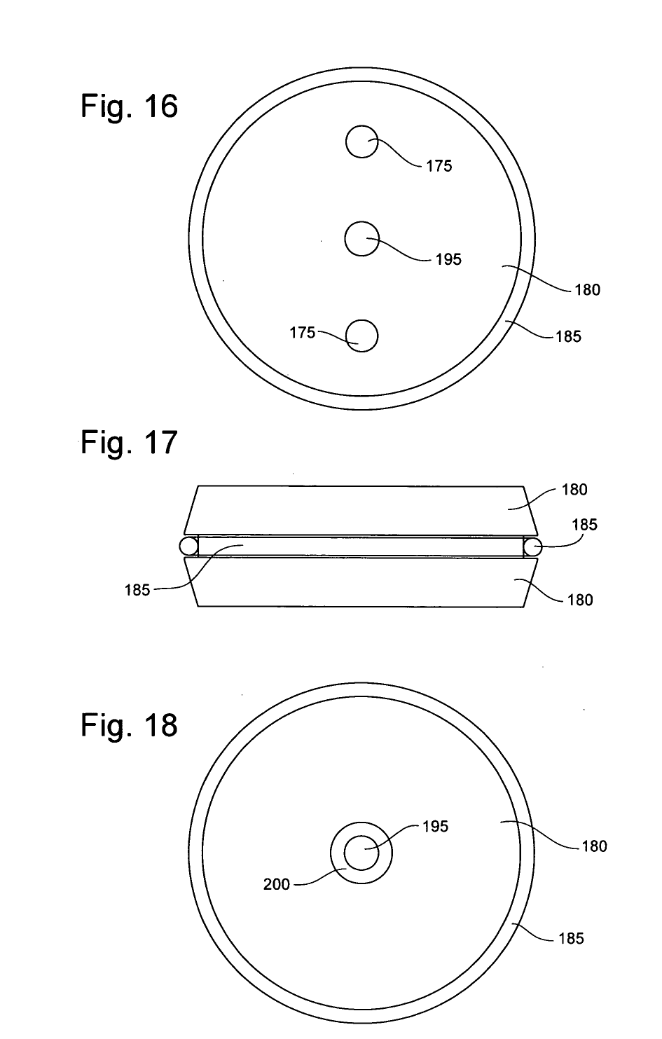

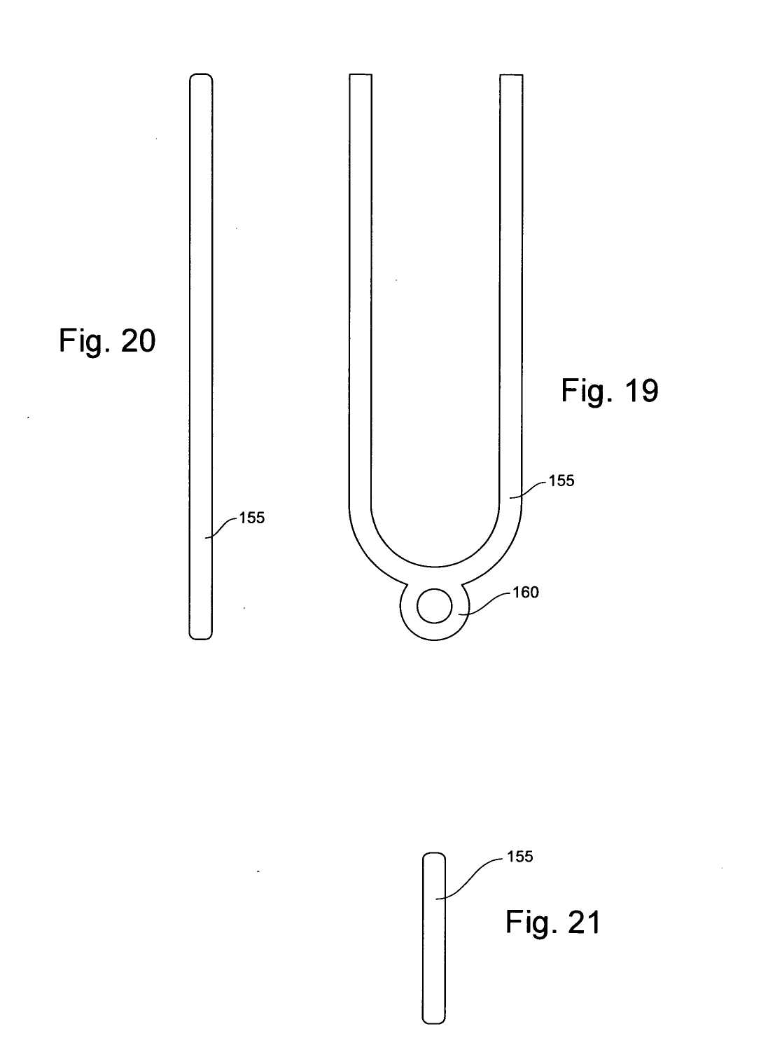

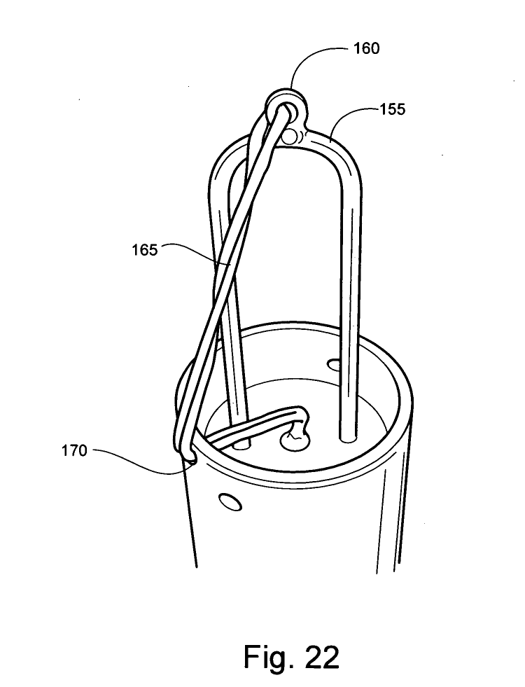

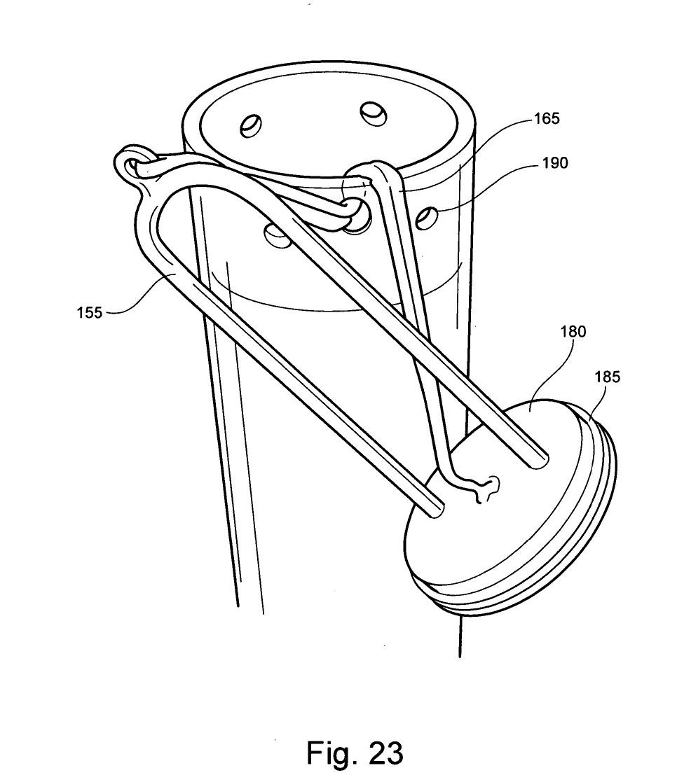

In another embodiment of the invention the chlorinator 140, FIG. 13 is fitted with an easy to remove top 150, which includes a top 180, FIG. 12, which is fitted with an O-ring 185. It is preferred that this O-ring be chlorine resistant. An example of such an O-ring is a Viton O-ring. Viton® is a fluoroelastomer made with Advanced Polymer Architecture (APA) which meets rigorous new sealing standards, available from DuPont Dow. The top 180, FIG. 16 has two orifices 175 in the upper side of the top 180 which only run down part way. The orifices 175 are configure for engagement of a tines of the security prong 155, FIG. 19. The top 180, may also be configured with an orifice 195 adapted to receive a tether 165, FIG. 13. It should also be noted that the top may also be configure without an orifice that runs all the way through and may have an attachment point affixed to the upper side of the top 180 for engagement of the tether. The lower side of said top 180 may be configured with a bottom indentation 200 so that if the top is configured with the through orifice 195 the tether 165 can be secured underneath while journaling the orifice 195. In this configuration a means for sealing would be inserted around the tether 165 and into the orifice 195. This means for sealing can be any means which includes but is not limited to a silicon sealant, glue, bonding material, or a sealant.

With the easy to remove top 150, the chlorinator 140, uses the elongated chlorine tablet chamber 80, which is configured with four orifices 190, FIG. 13, which are adapted to journal the security prong 155. The security prong 155 keeps the top 180 in place when the unit is put under pressure. The elongated chlorine tablet chamber 80, is fitted with another orifice 170 which journals the tether 165. The tether 165 is used to keep the top 180 attached to the security prong 155 so that they are not lost or miss placed.

The tether 165 can me made of a wide variety of materials which include but are not limited to nylon cord, hemp, jute, cotton, synthetic fibers, natural fibers, blends of natural fiber, blends of synthetic fibers and blends of natural and synthetic fiber. In addition the tether may me made of metal, chain, braided steel, or have a metal core wrapped in a synthetic or natural material. The top may be made of any material that is capable of withstanding the operating pressures without leaking and made be made of plastic, reinforced plastic, metal or a combination of these materials. It has been found that both stainless steel and aluminum work well in this application.

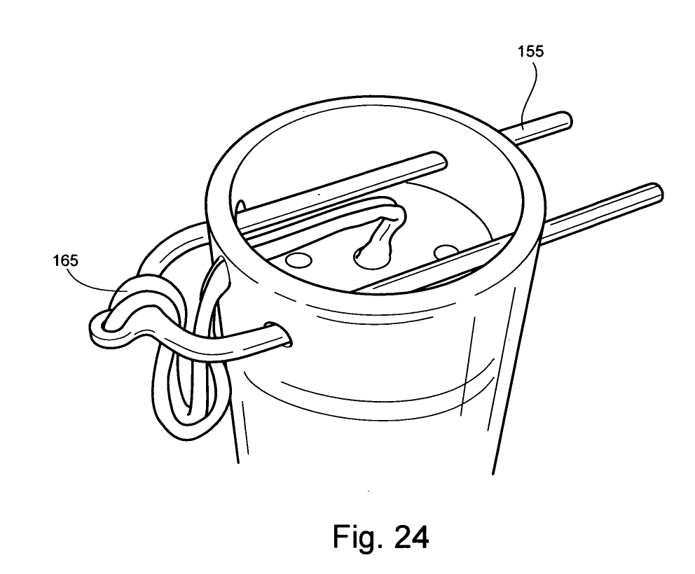

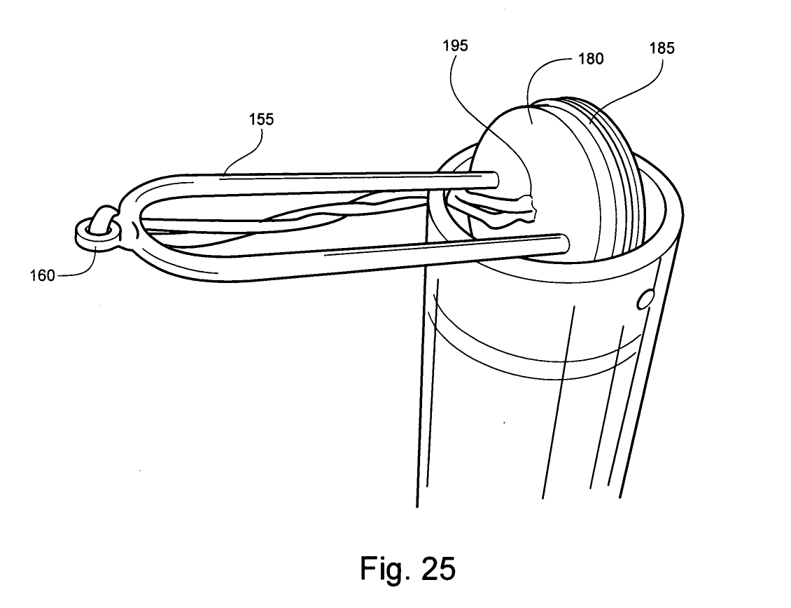

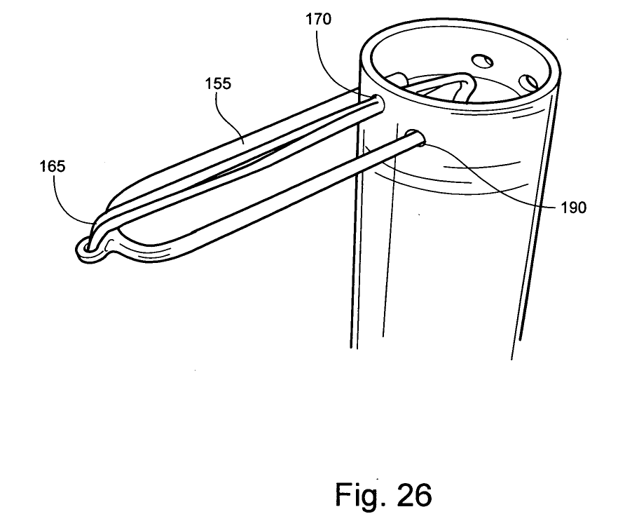

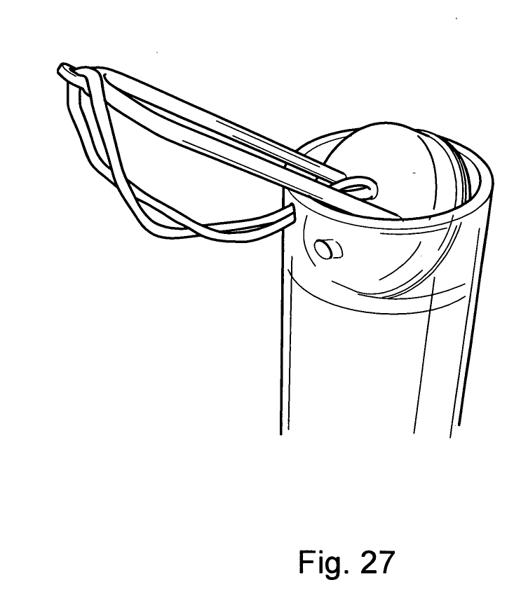

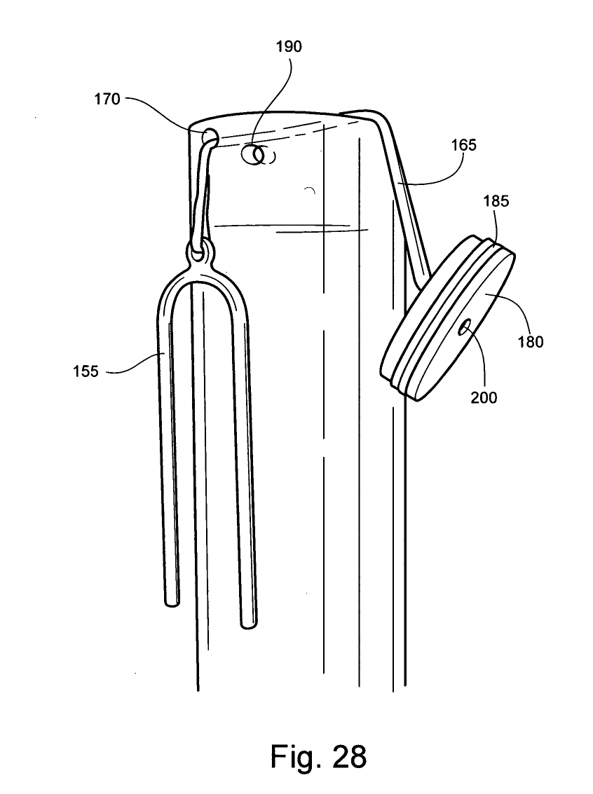

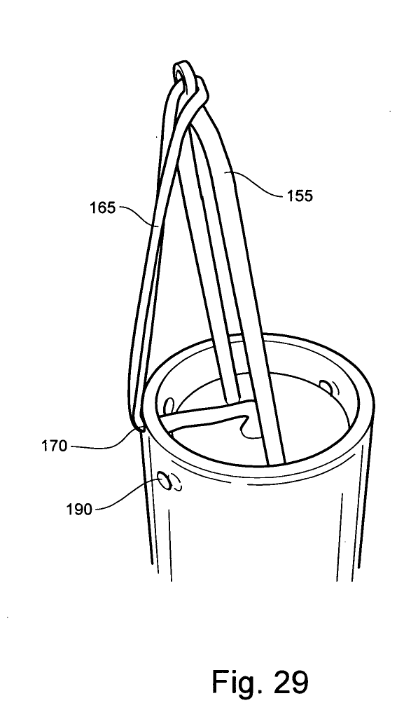

In operation the security prong's tines are inserted into the orifices 175 in the top 180 as shown in FIG. 23 so that the top 180 may be placed inside of the elongated chlorine tablet chamber 80, FIG. 25 and is adjusted (FIGS. 27 and 29) so that the top 180 is horizontally disposed inside of the elongated chlorine tablet chamber 80 as shown in FIG. 22. Then the tines of the security prong 155 are journaled through the orifices 190 in the elongated chlorine tablet chamber 80, as shown in FIGS. 26 and 24. Once the security prong is in place with the top 180 oriented correctly the unit may be placed under pressure. The O-ring 185 in the top assures a tight leak free fit even under pressures up to 400 psig.

When the chlorine tablets are used up the operation is reversed so that the security prong 155 is disengaged from the elongated chlorine tablet chamber 80, FIG. 26, and the tines of the security prong 155 are engaged in the top 180, FIG. 22, which is then removed, FIG. 25 from the elongated chlorine tablet chamber 80. Then the tablets are placed in the tablet chamber 80 and rests on the tablet holder 75, water enters the water inlet 35 and comes in contact with the tablet in the inner chamber and passes to the outlet chamber and is discharged via the water outlet 40. This chlorinator can operate under pressure to about 400 psig. This chlorinator can introduce a concentration of chlorine from 0.5 ppm to 10 ppm of chlorine into a stream of water flowing at a rate between 0.5 gpm to 15 gpm.

This chlorinator is adapted for use with any solid chlorine source.

What is claimed is:

1. A chlorinator that uses a chlorine tablet comprising:
a tablet chamber;
a contact chamber, said contact chamber having an inner chamber with a water inlet and an outer chamber with a water outlet;
a water diffuser located next to the inlet, and a tablet holder located adjacent the tablet chamber; and
wherein, a tablet is placed in the tablet chamber and rests on the tablet holder, water enters said water inlet and comes in contact with the tablet in the inner chamber and passes to the outlet chamber and is discharged via the water outlet.

2. The chlorinator according to claim 1 where said chlorinator operates under pressure up to 250 psig.

3. The chlorinator according to claim 1 where said chlorinator further comprises a sealable top attached to the tablet chamber opposite the contact chamber.

4. The chlorinator according to claim 1 where said tablet holder comprises a series of parallel plates within the inner chamber perpendicular to said diffuser.

5. The chlorinator according to claim 1 where said chlorinator can introduce a concentration of from 0.5 ppm to 10 ppm of chlorine into a stream of water flowing at a rate between 0.5 gpm to 15 gpm.

6. A chlorinator that uses a chlorine tablet comprising:
a contact chamber having a first end, a second end and a side wall;
a water inlet flow orifice at said first end of said contact chamber and being in communication with said contact chamber;
a water discharge orifice in said side wall of said contact chamber and being in communication with said contact chamber;
an inverted cone seated within the contact chamber and having a narrow end with an orifice and a wide end large enough to accept the chlorine tablet, said orifice at the narrow end is in communication with said water inlet orifice, intersected with a diffusion plate located at the narrow end of said cone, said diffusion plate is provided with a plurality of orifices, a series of parallel plates perpendicular to said diffusion plate is located at the wide end of said cone;
an elongated chlorine tablet chamber having a first end and a second end, said first end being joined to said second end of said contact chamber; and a closure cap at the second end of said elongated chlorine chamber.

7. The chlorinator according to claim 6 where the closure cap comprises:
a flange around the circumference of said elongated chlorine chamber, where said flange has a plurality of notches along the outside circumference of said flange;
an O-ring;
an end plate having a plurality of orifices spaced for communication with said plurality of notches in said flange;
fastening means adapted for engagement with the notches in the flange and the orifices in the end plate; and
where said O-ring is engaged between said flange and said end plate.

8. The chlorinator according to claim 6 where said elongated chlorine chamber is made from a transparent material.

9. The chlorinator according to claim 8 where said transparent material is a transparent polyvinyl chloride PVC.

10. The chlorinator according to claim 6 where said chlorinator can operate at pressures up to 250 psig.

11. The chlorinator according to claim 6 where said chlorinator can operate at a flowrate ranging from 1 gpm to 10 gpm.

12. The chlorinator according to claim 11 where said chlorinator can introduce a concentration of from 0.5 ppm to 10 ppm of chlorine into a water stream of water flowing at a rate of from 0.5 gpm to 15 gpm.

13. The chlorinator according to claim 6 where said elongated chlorine chamber is sized to hold ten three inch diameter chlorine tablets.

14. The chlorinator according to claim 7 where said second end of said elongated chlorine chamber is designed to be easily removed to allow introduction of the chlorine tablets, and then to be easily resealed, said O-ring is used to provide a seal between the top and said elongated chlorine chamber, so that the closure cap does not leak at pressures up to 400 psig.

15. The chlorinator according to claim 6 where the closure cap comprises:
a top adapted to fit snuggly inside of said elongated chlorine tablet chamber;
an O-ring adapted to fit about said top;
a security prong having at least one tine; and
a set of orifices in said second end of said elongated chlorine tablet chamber adapted to journal said tine.

16. The chlorinator according to claim 15 where the closure cap further comprises a tether which is secured to both the top and the security prong.

17. The chlorinator according to claim 15 where the security prong comprises at least two tines and said elongated chlorine tablet chamber having four orifices adapted to journal the two tines of the security prong.

18. A chlorinator that uses a chlorine tablet comprising:
a contact chamber having a first end, a second end and a side wall;
a water inlet flow orifice at said first end of said contact chamber and being in communication with said contact chamber;
a water discharge orifice in said side wall of said contact chamber and being in communication with said contact chamber;
an inverted cone seated within the contact chamber and having a narrow end with an orifice and a wide end large enough to accept the chlorine tablet, said orifice at the narrow end is in communication with said water inlet orifice, intersected with a diffusion plate located at the narrow end of said cone, said diffusion plate is provided with a plurality of orifices, a series of parallel plates perpendicular to said diffusion plate is located at the wide end of said cone;
an elongated chlorine tablet chamber having a first end and a second end, said first end being joined to said second end of said contact chamber; and a closure cap at the second end of said elongated chlorine chamber;
where said closure cap comprises:
a top adapted to fit snuggly inside of said elongated chlorine tablet chamber;
an O-ring adapted to fit about said top;
a security prong having at least one tine; and
a set of orifices in said second end of said elongated chlorine tablet chamber adapted to journal said tine; and
where said closure cap operates at pressures up to 400 psig.

19. The chlorinator according to claim 18 where the closure cap further comprises a tether which is secured to both the top and the security prong.

20. The chlorinator according to claim 15 where the security prong comprises at least two tines and said elongated chlorine tablet chamber having four orifices adapted to journal the two tines of the security prong.
